(19) United States
(12) Patent Application Publication
(10) Pub. No.: US 2015/0371551 A1
(43) Pub. Date: Dec. 24, 2015

(54) SPEADING SPEED READING AND COMPREHENSION PROGRAM

(71) Applicant: D'Jameon Stearns, Humble, TX (US)

(72) Inventor: D'Jameon Stearns, Humble, TX (US)

(21) Appl. No.: 14/742,982

(22) Filed: Jun. 18, 2015

Related U.S. Application Data
(60) Provisional application No. 62/013,891, filed on Jun. 18, 2014.

(51) Int. Cl. G09B 17/04; G09B 7/00

(52) U.S. Cl. CPC G09B 17/04; G09B 7/00

(57) ABSTRACT

A speed reading and comprehension program for assisting readers in reading faster and better understanding content is provided. The speed reading and comprehension program comprises a computer having a display screen and a software program operatable by the computer. The software program displays predetermined text on the display screen of the computer. The software program presents a predetermined number of paragraphs on the display screen and then presents a plurality of questions. Upon correctly answering a predetermined percentage of questions, the computer software moves to a higher difficulty level thereby increasing an individual's reading speed and reinforces reading comprehension.

The present application claims the benefit of priority of pending provisional patent application Ser. No. 62/013,891, filed on Jun. 18, 2014, entitled “Speading”.

### BACKGROUND OF THE INVENTION

1. Field of the Invention

This invention relates generally to a speed reading and comprehension program and, more particularly, the invention relates to a speed reading and comprehension program for assisting readers in reading faster and understanding the content they are reading.

2. Description of the Prior Art

Illiteracy and poor reading skills are continuing issues that exist worldwide in undeveloped and developed countries alike. Millions of children and adults never learn to read during their lifetime. Additionally, millions of children pass through their school years and on into college and adulthood without the ability to read and learn at a proficient level. The prior art has put forth several designs for software to improve reading skills. Among these are:

US Patent 2009/0142737 to Donna J. Breig describes a system and method for developing reading skills, the system comprising a processor and a reader interface in communication with one another. The processor is structured to run at least one computer program for facilitating interactive multimedia learning relating to the development of reading skills. The reader interface is structured to present multimedia content, including a text based passage to a reader, and to receive input from the reader. The reader interface is further structured to display animated text and to permit placement of the animated text in a location that facilitates viewing thereof The reader interface also comprises audio and graphic aids which correspond to the text based passage. Additionally, the processor is structured to measure and track at least one reading performance indicator.

U.S. Pat. No. 6,409,513 to Akihiro Kawamura, describes a system which utilizes a series of computer controlled exercises designed to strengthen eye muscles to reduce eye fatigue, increase overall reading speed by performing variable reading speed exercises, and enhance an eye brain connection to improve reading comprehension and maintain the speed reading and comprehension skills. A specific variable reading rate process has the reader read at a first rate, then increase to a second rate, and finally decrease to a third reading rate that is faster than the first rate and slower than the second rate. Eye brain connection enhancement exercises include following objects moving in specific patterns across a computer screen, expanding peripheral vision by watching and following the outline of expanding objects, rapidly solving maze puzzles, sequentially locating a series of numbers on a single display screen, and two point horizontal and vertical scanning.

U.S. Pat. No. 4,820,167 to Anthony A. Nobles, Verne H. Nobles, Jon H. Fleming, Charles T. Terrell and Alexander K. Lai describes an electronic school teaching system that includes a data collection computer, a teacher's computers and a student's electronic and test units. The data collection computer is located in the school's administration office and connected to a plurality of teacher's computers located in a corresponding plurality of school rooms, and a plurality of student's read and test units are connectable to each of the teacher's computers. The data collection computer receives student related data including textbook updates to the teacher's computers. The teacher's computers are connectable to the student's read and test units for writing homework assignments, tests, and grades and reading student identification, homework, and test information. The student's read and test units include electronic textbook memory modules, one for each course, a memory module for receiving the homework assignments, an open book size housing for a display, keyboard, and microprocessor. The display shows left and right pages of the textbook. The keyboard includes left and right page turning keys in the upper left and right corners, numeric keys for page and chapter location, alphabetical keys for answering test questions and calling up each textbook, and true, false, yes, and no keys for answering questions conveniently located around the border of the textbook. The operation of the unit simulates the use of a normal textbook, so the level of difficulty in learning to use the unit is minimal. None of these prior art references describe the present invention.

### SUMMARY

The present invention is a speed reading and comprehension program for assisting readers in reading faster and better understanding content. The speed reading and comprehension program comprises a computer having a display screen and a software program operatable by the computer. The software program displays predetermined text on the display screen of the computer. The software program presents a predetermined number of paragraphs on the display screen and then presents a plurality of questions. Upon correctly answering a predetermined percentage of questions, the computer software moves to a higher difficulty level thereby increasing an individual's reading speed and reinforces reading comprehension.

In addition, the present invention includes a method for assisting readers in reading faster and better understanding content. The method comprises providing a computer having a display screen, operating a software program by the computer, displaying predetermined text on the display screen of the computer, presenting a predetermined number of paragraphs on the display screen for the reader to read, presenting a plurality of questions, moving to a higher difficulty level upon answering a predetermined percentage of questions correctly, and increasing reading speed and reinforces reading comprehension.

The present invention further includes a speed reading and comprehension program for assisting readers in reading faster and better understanding content. The speed reading and comprehension program comprises a computer having a display screen and a software program operatable by the computer. The software program displays predetermined text on the display screen of the computer. The software program presents a predetermined number of paragraphs on the display screen with the software program discerning key words in each sentence then combining the words in context. The software program then presents the readers a plurality of questions. Upon answering a predetermined percentage of questions correctly, the computer software moves to a higher difficulty level. Upon completion of a predetermined number of levels, the computer program presents a professional level operating with added noises in the background thereby increasing an individual's reading speed and reinforces reading comprehension.

### BRIEF DESCRIPTION OF THE DRAWINGS

FIG. 1 is a perspective view illustrating a speed reading and comprehension program, constructed in accordance with the present invention.

### DETAILED DESCRIPTION OF THE PREFERRED EMBODIMENTS

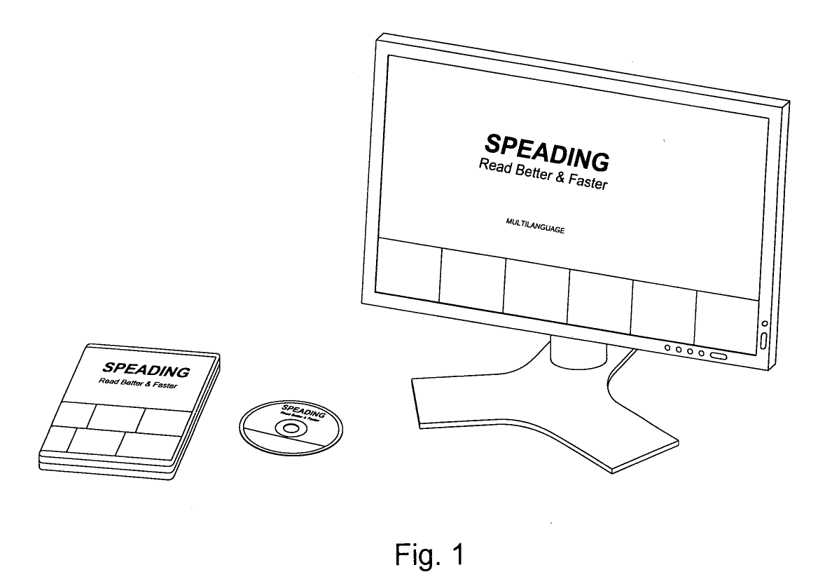

As illustrated in FIG. 1, the present invention is a speed reading and comprehension program, indicated generally at 10, for assisting readers in reading faster and better understanding the content they are reading. The speed reading and comprehension program 10 is a computer software program assisting both children and adults in improving their reading and learning skills. The program 10 increases an individual's reading speed and reinforces reading comprehension and provides beginning and slow readers with tools and techniques they need to help them read faster as well as improve their comprehension of the materials they are reading. The program 10 is compatible with any operating system used in PCs, Macs, tablets and smart phones.

The speed reading and comprehension program 10 of the present invention presents specialized exercises geared to appropriate age and reading levels that incorporate methods to help users better accomplish reading tasks. Broadly, the methods include discerning key words in each sentence then combining them in context, eliminating the need for a reader to labor over each individual word. Techniques in softening the eyes, so that one's gaze is expanded and can pick out blocks of words more clearly, also help speed the reading process. Directional reading techniques are taught with the program 10, where lines in paragraphs are read alternately with the first line read left to right as normal and the second line read right to left.

Specifically, in a preferred embodiment, the speed reading and comprehension program 10 of the present invention presents two paragraphs moving up on the screen for the reader to read. After reading the two paragraphs, the reader is asked six questions and must get 90% of the answers right in order to move on to the next level that increases the speed of the moving paragraph. There are 10 levels that readers go through with different levels of paragraph speed. Once all 10 levels have been passed, the reader experiences the professional level that operates the same way as the normal levels but has added noises in the background as the reader reads the moving paragraphs. The added background noise is preferably a person's voice having a random conversation with another person to distract the reader. Both normal and professional levels have ten (b 10) levels. The speed reading and comprehension program 10 of the present invention is preferably offered in multiple languages helping those who have learned new languages or just help those who only speak one language.

An exciting presentation for printed matter, the speed reading and comprehension program 10 of the present invention is a fun computer program appealing to young children, encouraging them to practice with the system and then eventually pick up a book because they enjoy reading and want to read. Parents are provided a much needed tool in starting their child's reading development as soon as possible, since parents are the child's first teachers. By the time a child enters kindergarten, his or her reading and comprehension skills foster a sense of confidence in their abilities, and a readiness and willingness to want to learn more. Using the program 10 also speeds up the learning process, and helps users learn a new language more quickly and thoroughly. The program 10 is presented in a variety of languages in a series of consecutive levels to reward and encourage the reader as their proficiency increases. After the regular levels have been mastered, the user can embark on the professional level, wherein background noise is provided to encourage retention of material in the presence of background distraction wherein the user is tested at the end of the level for comprehension.

The speed reading and comprehension program 10 of the present invention is highly productive software in that it helps educators more successfully impart lessons to students who are much more receptive to the learning process. The program 10 is useful for older students and adults who wish to improve their reading skills, helping them to get into the college of their choice while also improving job opportunities while also reducing illiteracy rates and increasing learning capability.

In sum, the speed reading and comprehension program 10 of the present invention teaches beginning and slow readers the tools they need to help them read faster, as well as improve their comprehension of the materials they are reading. The program 10 is compatible with virtually any operating system, from PCs and Macs to possibly even mobile devices such as tablets and smartphones. The program 10 presents specialized exercises geared to appropriate age and reading levels that incorporate methods or “tricks” to help users better accomplish reading tasks. Some ideas that may be incorporated into the program 10 includes exercises in discerning key words in each sentence, then combining them in context so that one does not have to labor over each individual word; techniques in softening the eyes, so that one's gaze is expanded and can pick out blocks of words more clearly, which can help speed the reading process; or directional reading techniques, where lines in paragraphs are read alternately, with the first line read left to right, as normal, and the second line read right to left. It should be noted that the preceding are suggested ideas only and do not indicate that these exact techniques will be incorporated into the program 10.

The speed reading and comprehension program 10 of the present invention will widely appeal to young children, encouraging them to practice with the system and eventually, pick up a book because they want to, not because they have to. In this manner, the program 10 gives parents a needed tool in starting their child's reading development as soon as possible, since parents are really the child's first teachers. As such, parents are able to better instill a desire to learn at a much earlier age, so that by the time the child enters kindergarten, his or her reading and comprehension skills would foster a sense of confidence in their abilities, and readiness, and willingness, to want to learn more. In addition, the program 10 speeds up the learning process, helping users to learn a new language or several new languages.

The speed reading and comprehension program 10 of the present invention also benefits teachers, helping educators more successfully impart lessons to students who are much more receptive to the learning process. The program 10 can also prove greatly beneficial to older students and adults who wish to improve their reading skills, helping them to get into the college of their choice while also improving job opportunities. On the professional level, the program 10 teaches the user how to read faster with greater comprehension even when background noises are present. The methods used by the program 10 serves to keep the reader focused on what they are reading, and not their distracting surroundings. The program 10 offers a creative product that conceivably reduces illiteracy rates by a significant margin, and should be well received by parents, teachers, children, and adults.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

What is claimed is:

1. A speed reading and comprehension program for assisting readers in reading faster and better understanding content, the speed reading and comprehension program comprising:
a computer having a display screen;
a software program operatable by the computer, the software program displaying predetermined text on the display screen of the computer;
wherein the software program presents a predetermined number of paragraphs on the display screen;
wherein the software program then presents a plurality of questions;
wherein upon correctly answering a predetermined percentage of questions, the computer software moves to a higher difficulty level; and
wherein the program increases an individual's reading speed and reinforces reading comprehension.

2. The speed reading and comprehension program of claim 1 wherein the software program discerns key words in each sentence then combining the words in context.

3. The speed reading and comprehension program of claim 1 wherein the number of paragraphs on the display screen is two.

4. The speed reading and comprehension program of claim 1 wherein the number of questions is six.

5. The speed reading and comprehension program of claim 1 wherein the percentage of questions is ninety (90%) percent.

6. The speed reading and comprehension program of claim 1 wherein the number of levels is ten.

7. The speed reading and comprehension program of claim 6 wherein upon completing ten (10) levels, the computer program presents a professional level operating with added noises in the background.

8. The speed reading and comprehension program of claim 7 wherein the added background noise is a person's voice.

9. The speed reading and comprehension program of claim 8 wherein the background noise is a random conversation with at least two voices.

10. The speed reading and comprehension program of claim 7 wherein the professional level have ten (10) levels.

11. The speed reading and comprehension program of claim 1 wherein the text is offered in multiple languages.

12. A method for assisting readers in reading faster and better understanding content, the method comprising:
providing a computer having a display screen;
operating a software program by the computer;
displaying predetermined text on the display screen of the computer;
presenting a predetermined number of paragraphs on the display screen for the reader to read;
presenting a plurality of questions;
moving to a higher difficulty level upon answering a predetermined percentage of questions correctly; and
increasing reading speed and reinforces reading comprehension.

13. The method of claim 12 and further comprising:
discerning key words in each sentence then combining the words in context.

14. The method of claim 12 and further comprising:
presenting a professional level operating with added noises in the background upon completing the predetermined number of levels.

15. The method of claim 14 wherein the added background noise is a person's voice.

16. The method of claim 15 wherein the background noise is a random conversation with at least two voices.

17. The method of claim 12 and further comprising:
offering the text in multiple languages.

18. A speed reading and comprehension program for assisting readers in reading faster and better understanding content, the speed reading and comprehension program comprising:
a computer having a display screen;
a software program operatable by the computer, the software program displaying predetermined text on the display screen of the computer;
wherein the software program presents a predetermined number of paragraphs on the display screen, the software program discerning key words in each sentence then combining the words in context;
wherein the software program then presents the readers a plurality of questions;
wherein upon answering a predetermined percentage of questions correctly, the computer software moves to a higher difficulty level;
wherein upon completion of a predetermined number of levels, the computer program presents a professional level operating with added noises in the background; and
wherein the program increases an individual's reading speed and reinforces reading comprehension.

19. The speed reading and comprehension program of claim 18 wherein the added background noise is a person's voice.

20. The speed reading and comprehension program of claim 19 wherein the background noise is a random conversation with at least two voices.
